(19) United States
(12) Patent Application Publication
(10) Pub. No.: US 2006/0229408 A1
(43) Pub. Date: Oct. 12, 2006

(54) Curable resin composition for sealing LED element

(75) Inventors: Hisashi Shimizu, Annaka-shi (JP); Tsutomu Kashiwagi, Annaka-shi (JP); Toshio Shiobara, Annaka-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Shin-Etsu Chemical Co., Ltd., Chiyoda-ku (JP)

(21) Appl. No.: 11/399,434

(22) Filed: Apr. 7, 2006

(30) Foreign Application Priority Data
Apr. 8, 2005 (JP) 2005-112803

(51) Int. Cl. C08L 83/06; C08G 77/08

(52) U.S. Cl. 524/588; 528/14; 528/17

(57) ABSTRACT

A curable resin composition for sealing an LED element is provided. The composition includes (i) an organopolysiloxane with a polystyrene equivalent weight average molecular weight of at least 5×10³, (ii) a condensation catalyst, (iii) a solvent, and (iv) a finely powdered inorganic filler. It is suited to formation of a coating film or the like with excellent heat resistance, ultraviolet light resistance, optical transparency, toughness and adhesion, and is ideal for applications such as the sealing of LED elements.

### BACKGROUND OF THE INVENTION

1. Field of the Invention

The present invention relates to an optical material, and more specifically to an optical material with excellent levels of heat resistance, ultraviolet light resistance, optical transparency, toughness and adhesion, and relates particularly to a resin composition that can be screen printed, and is ideal for applications such as the sealing of LED elements.

2. Description of the Prior Art

Due to their favorable workability and ease of handling, highly transparent epoxy resins and silicone resins are widely used as sealants for LED elements.

Recently however, LEDs with shorter wavelengths such as blue LEDs and ultraviolet LEDs have been developed, and the potential applications for these diodes are expanding rapidly. Under these circumstances, conventional epoxy resins and silicone resins present various problems, including yellowing of the resin under strong ultraviolet light, or even rupture of the resin skeleton in severe cases, meaning the use of such resins is becoming increasingly difficult. In the case of ultraviolet LED applications, resin sealing is particularly problematic, meaning sealing with glass is currently the only viable option.

Accordingly, the development of a resin composition with excellent optical transparency and ultraviolet light resistance, that retains the superior levels of heat resistance, toughness and adhesion required for a sealant, while also resolving the problems described above has been keenly sought.

### SUMMARY OF THE INVENTION

An object of the present invention is to provide a curable resin composition which, on curing, is capable of forming a coating film or the like with excellent levels of heat resistance, ultraviolet light resistance, optical transparency, toughness and adhesion, and which is useful for applications such as the sealing of LED elements.

As a result of intensive research aimed at achieving the above object, the inventors of the present invention discovered that a composition described below, and a cured product of that composition, were able to achieve the above object.

In other words, the present invention provides a curable resin composition for sealing an LED element, comprising:

(i) an organopolysiloxane with a polystyrene equivalent weight average molecular weight of at least 5×10³, represented by an average composition formula (1) shown below:
R¹ₐ(OX)_{b}SiO_{(4-a-b)/2} (1)
(wherein, each R¹ represents, independently, an alkyl group, alkenyl group or aryl group of 1 to 6 carbon atoms, each X represents, independently, a hydrogen atom, or an alkyl group, alkenyl group, alkoxyalkyl group or acyl group of 1 to 6 carbon atoms, a represents a number within a range from 1.05 to 1.5, b represents a number that satisfies 0<b<2, and a+b represents a number that satisfies 1.05<a+b<2),

(ii) a condensation catalyst,

(iii) a solvent, and

(iv) a finely powdered inorganic filler.

Furthermore, the present invention also provides a cured product obtained by curing the above composition.

On curing, a curable resin composition of the present invention yields a cured product that exhibits excellent levels of heat resistance, ultraviolet light resistance, optical transparency, toughness and adhesion, as well as a small birefringence. In addition, the composition also exhibits thixotropic properties, meaning it can be used for screen printing, and offers excellent workability. This composition is useful for sealing LED elements as well as other applications.

### DETAILED DESCRIPTION OF THE PREFERRED EMBODIMENTS

As follows is a more detailed description of the present invention. In this description, room temperature is defined as 24±2° C.

<Organopolysiloxane (i)>

The organopolysiloxane of the component (i) is represented by the average composition formula (1) shown above, and has a polystyrene equivalent weight average molecular weight of at least 5×10³.

In the above average composition formula (1), examples of suitable alkyl groups represented by R¹ include a methyl group, ethyl group, propyl group, or butyl group. An example of suitable alkenyl groups include a vinyl group or allyl group. An example of a suitable aryl group is a phenyl group. Of these, a methyl group is preferred as the R¹ group, as the resulting cured product exhibits superior levels of heat resistance and ultraviolet light resistance and the like.

Examples of suitable alkyl groups represented by X include a methyl group, ethyl group, propyl group, isopropyl group, butyl group, or isobutyl group. An example of a suitable alkenyl group is a vinyl group. Examples of suitable alkoxyalkyl groups include a methoxyethyl group, ethoxyethyl group, or butoxyethyl group. Examples of suitable acyl groups include an acetyl group or propionyl group. Of these, a hydrogen atom, methyl group or isobutyl group is preferred as the X group.

a is preferably a number within a range from 1.15 to 1.25, and b is preferably a number that satisfies 0.01≦b<1.4, and even more preferably 0.01≦b≦1.0, and most preferably 0.05≦b≦0.3. If the value of a is less than 1.05, then cracks are more likely to form in the cured product, whereas if the value exceeds 1.5, the cured product loses toughness, is prone to becoming brittle, and may suffer a deterioration in heat resistance and ultraviolet light resistance. If b is zero, then the adhesiveness relative to substrates deteriorates, whereas if b is 2 or greater, a cured product may be unobtainable. Furthermore, a+b is preferably a number that satisfies 1.06≦a+b≦1.8, and even more preferably 1.1≦a+b≦1.7.

Furthermore, in order to ensure a more superior level of heat resistance for the cured product, the (mass referenced) proportion of R¹ groups, typified by methyl groups, within the organopolysiloxane of this component is typically no more than 32% by mass, and preferably within a range from 15 to 32% by mass, even more preferably from 20 to 32% by mass, and most preferably from 25 to 31% by mass. If this proportion of R¹ groups is too low, then the coating moldability or coating crack resistance may deteriorate.

The organopolysiloxane of this component can be produced either by hydrolysis and condensation of a silane compound represented by a general formula (2) shown below:
SiR¹_{c}(OR²)_{4-c} (2)
(wherein, each R¹ represents, independently, a group as defined above, each R² represents, independently, a group as defined above for X but excluding a hydrogen atom, and c represents an integer of 1 to 3), or by cohydrolysis and condensation of a silane compound represented by the general formula (2), and an alkyl silicate represented by a general formula (3) shown below:
Si(OR²)₄ (3)
(wherein, each R² represents, independently, a group as defined above) and/or a condensation polymerization product of the alkyl silicate (an alkyl polysilicate) (hereafter referred to jointly as an alkyl (poly)silicate).

Both the silane compound and the alkyl (poly)silicate may be used either alone, or in combinations of two or more different materials.

Examples of the silane compound represented by the above general formula (2) include methyltrimethoxysilane, methyltriethoxysilane, ethyltrimethoxysilane, ethyltriethoxysilane, phenyltrimethoxysilane, phenyltriethoxysilane, dimethyldimethoxysilane, dimethyldiethoxysilane, diphenyldimethoxysilane, diphenyldiethoxysilane, methylphenyldimethoxysilane and methylphenyldiethoxysilane, and of these, methyltrimethoxysilane and dimethyldimethoxysilane are preferred.

These silane compounds may be used either alone, or in combinations of two or more different compounds.

Examples of the alkyl silicate represented by the above general formula (3) include tetraalkoxysilanes such as tetramethoxysilane, tetraethoxysilane and tetraisopropyloxysilane, and examples of the condensation polymerization product of the alkyl silicate (the alkyl polysilicate) include methyl polysilicate and ethyl polysilicate.

These alkyl (poly)silicates may be used either alone, or in combinations of two or more different materials.

Of these possibilities, the organopolysiloxane of this component is preferably formed from 50 to 95 mol % of an alkyltrialkoxysilane such as methyltrimethoxysilane, and 50 to 5 mol % of a dialkyldialkoxysilane such as dimethyldimethoxysilane, as such a composition ensures superior levels of crack resistance and heat resistance in the resulting cured product, and organopolysiloxanes formed from 75 to 85 mol % of an alkyltrialkoxysilane such as methyltrimethoxysilane, and 25 to 15 mol % of a dialkyldialkoxysilane such as dimethyldimethoxysilane are even more desirable.

In a preferred embodiment of the present invention, the organopolysiloxane of this component can be obtained either by hydrolysis and condensation of the silane compound described above, or by cohydrolysis and condensation of the silane compound and an alkyl (poly)silicate, and although there are no particular restrictions on the method used for the reaction, the conditions described below represent one example of a suitable method.

The above silane compound and alkyl (poly)silicate are preferably dissolved in an organic solvent such as an alcohol, ketone, ester, cellosolve, or aromatic compound prior to use. Specific examples of preferred solvents include alcohols such as methanol, ethanol, isopropyl alcohol, isobutyl alcohol, n-butanol and 2-butanol, and of these, isobutyl alcohol is particularly preferred as it produces superior levels of curability for the resulting composition, and excellent toughness of the cured product.

In addition, the above silane compound and alkyl (poly)silicate are preferably subjected to hydrolysis and condensation in the presence of an acid catalyst such as acetic acid, hydrochloric acid, or sulfuric acid. The quantity of water added during the hydrolysis and condensation is typically within a range from 0.9 to 1.5 mols, and preferably from 1.0 to 1.2 mols, relative to each mole of the combined quantity of alkoxy groups within the silane compound and the alkyl (poly)silicate. If this blend quantity falls within the range from 0.9 to 1.5 mols, then the resulting composition exhibits excellent workability, and the cured product exhibits excellent toughness.

The polystyrene equivalent weight average molecular weight of the organopolysiloxane of this component is preferably set, using aging, to a molecular weight just below the level that results in gelling, and from the viewpoints of ease of handling and pot life, must be at least 5×10³, and is preferably within a range from 5×10³ to 3×10⁶, and even more preferably from 1×10⁴ to 1×10⁵. If this molecular weight is less than 5×10³, then the composition is prone to cracking on curing. If the molecular weight is too large, then the composition becomes prone to gelling, and the workability deteriorates.

The temperature for conducting the aging described above is preferably within a range from 0 to 40° C., and is even more preferably room temperature. If the aging temperature is from 0 to 40° C., then the organopolysiloxane of this component develops a ladder-type structure, which provides the resulting cured product with excellent crack resistance.

The organopolysiloxane of the component (i) may use either a single compound, or a combination of two or more different compounds.

<Condensation Catalyst (ii)>

The condensation catalyst of the component (ii) is necessary to enable curing of the organopolysiloxane of the component (i). There are no particular restrictions on the condensation catalyst, although in terms of achieving favorable stability for the organopolysiloxane and excellent levels of hardness and ultraviolet light resistance for the resulting cured product, an organometallic catalyst is normally used. Examples of this organometallic catalyst include compounds that contain zinc, aluminum, titanium, tin, or cobalt atoms, and compounds that contain zinc, aluminum, or titanium atoms are preferred. Specific examples of suitable compounds include organic acid zinc compounds, Lewis acid catalysts, organoaluminum compounds, and organotitanium compounds, and more specific examples include zinc octylate (i.e. zinc octoate), zinc benzoate, zinc p-tert-butylbenzoate, zinc laurate, zinc stearate, aluminum chloride, aluminum perchlorate, aluminum phosphate, aluminum triisopropoxide, aluminum acetylacetonate, aluminum butoxy-bis(ethylacetoacetate), tetrabutyl titanate, tetraisopropyl titanate, tin octylate, cobalt naphthenate, and tin naphthenate, and of these, zinc octylate is preferred.

The blend quantity of the component (ii) is typically within a range from 0.05 to 10 parts by mass per 100 parts by mass of the component (i), although in terms of obtaining a composition with superior levels of curability and stability, a quantity within a range from 0.1 to 5 parts by mass is preferred.

The condensation catalyst of the component (ii) may use either a single compound, or a combination of two or more different compounds.

<Solvent (iii)>

The solvent of the component (iii) is particularly necessary when screen printing the composition, in order to ensure a favorable level of moldability for the cured product. There are no particular restrictions on this solvent, although the boiling point of the solvent is preferably at least 64° C., even more preferably within a range from 70 to 230° C., and most preferably from 80 to 200° C. If the boiling point falls within this range, then during screen printing, voids generated by the presence of foam do not occur within the composition or the cured product, and the whitening phenomenon observed at the composition surface is also prevented, enabling a favorable molded product to be obtained.

Examples of the solvent of this composition include hydrocarbon-based solvents such as benzene, toluene, and xylene; ether-based solvents such as tetrahydrofuran, 1,4-dioxane, and diethyl ether; ketone-based solvents such as methyl ethyl ketone; halogen-based solvents such as chloroform, methylene chloride, and 1,2-dichloroethane; alcohol-based solvents such as methanol, ethanol, isopropyl alcohol, and isobutyl alcohol; as well as organic solvents with boiling points of less than 150° C. such as octamethylcyclotetrasiloxane and hexamethyldisiloxane, and organic solvents with boiling points of 150° C. or higher such as cellosolve acetate, cyclohexanone, butyl cellosolve, methylcarbitol, carbitol, butylcarbitol, diethylcarbitol, cyclohexanol, diglyme, and triglyme, and of these, xylene, isobutyl alcohol, diglyme, and triglyme are preferred.

These organic solvents may be used either alone, or in combinations of two or more different solvents, although the use of a combination of two or more solvents is preferred as it produces superior leveling characteristics for the applied surface of the composition. In addition, a solvent that comprises at least one organic solvent with a boiling point of 150° C. or higher is particularly preferred as it results in more favorable curing of the composition during screen printing of the composition, and yields a cured product with excellent workability. The proportion of this organic solvent with a boiling point of 150° C. or higher within this component is preferably within a range from 5 to 30% by mass, even more preferably from 7 to 20% by mass, and most preferably from 8 to 15% by mass.

There are no particular restrictions on the blend quantity of this component (iii), although the quantity is preferably no more than 233 parts by mass, even more preferably within a range from 10 to 100 parts by mass, and most preferably from 20 to 80 parts by mass, per 100 parts by mass of the component (i). In other words, the quantity of the component (i) relative to the combined quantity of the component (i) and the component (iii) is preferably at least 30% by mass, even more preferably within a range from 50 to 91% by mass, and most preferably from 55 to 83% by mass. A quantity that satisfies this range improves the moldability of the cured product, and simplifies the processing required to produce a typical thickness for the cured product, in a dried state, within a range from 10 μm to 3 mm, and even more typically from 100 μm to 3 mm.

<Finely Powdered Inorganic Filler (iv)>

The finely powdered inorganic filler of the component (iv) imparts, to the composition, the thixotropic properties that are required during screen printing. In addition, the blending of this inorganic filler also provides other effects, such as ensuring that the light scattering properties of the cured product (such as a low birefringence) and the flowability of the composition fall within appropriate ranges, and strengthening materials that use the composition.

Although there are no particular restrictions on the specific surface area of the finely powdered inorganic filler as determined by a BET method (the BET specific surface area), in those cases where the composition is used for screen printing, this value is preferably at least 100 m²/g (typically within a range from 100 to 400 m²/g), even more preferably 180 m²/g or greater, and most preferably within a range from 200 to 350 m²/g. If the BET specific surface area falls within this range, then thixotropic properties that enable favorable moldability retention are obtained, meaning the blend quantity of this component can be reduced.

There are no particular restrictions on the inorganic filler used to form the finely powdered inorganic filler, and suitable examples include silica, alumina, aluminum hydroxide, titanium oxide, iron oxide, calcium carbonate, magnesium carbonate, aluminum nitride, magnesium oxide, zirconium oxide, boron nitride, and silicon nitride, although generally, silica offers the most suitable particle size and purity, and is consequently preferred.

This silica, namely a finely powdered silica, can use conventional materials, and either wet silica or dry silica is suitable. Specific examples of suitable silica materials include precipitated silica, silica xerogel, fumed silica, fused silica, crystalline silica, or silica in which the surface has been subjected to hydrophobic treatment with organosilyl groups. Examples of suitable commercially available products, listed in terms of their product names, include Aerosil (manufactured by Nippon Aerosil Co., Ltd.), Nipsil (manufactured by Nippon Silica Industry Co., Ltd.), Cabosil (manufactured by Cabot Corporation, U.S.A.), and Santocel (manufactured by Monsanto Company Ltd.).

There are no particular restrictions on the blend quantity of this component (iv), although the quantity is preferably within a range from 5 to 40 parts by mass, even more preferably from 15 to 25 parts by mass, and most preferably from 18 to 20 parts by mass, per 100 parts by mass of the aforementioned component (i). If the blend quantity satisfies this range, then not only is the workability of the resulting composition favorable, but the thixotropic properties required for screen printing are also satisfactory.

The finely powdered inorganic filler of the component (iv) may be used either alone, or in combinations of two or more different materials.

<Other Components>

In addition to the aforementioned components (i) through (iv), other optional components can also be added to a composition of the present invention, provided such addition does not impair the actions or effects of the present invention. These other components may be used either alone, or in combinations of two or more different materials.

Examples of these other optional components include inorganic phosphors, age resistors, radical inhibitors, ultraviolet absorbers, adhesion improvers, flame retardants, surfactants, storage stability improvers, antiozonants, photostabilizers, thickeners, plasticizers, coupling agents, antioxidants, thermal stabilizers, conductivity imparting agents, antistatic agents, radiation blockers, nucleating agents, phosphorus-based peroxide decomposition agents, lubricants, pigments, metal deactivators, and physical property modifiers.

Examples of suitable inorganic phosphors include the types of materials that are widely used in LEDs, such as yttrium aluminum garnet (YAG) phosphors, ZnS phosphors, Y₂O₂S phosphors, red light emitting phosphors, blue light emitting phosphors, and green light emitting phosphors.

<Method of Preparation>

A composition of the present invention can be prepared by mixing together the aforementioned components (i) through (iv), and any optional components that are to be added, using any arbitrary mixing method. In a specific example, the organopolysiloxane of the component (i), the solvent of the component (iii), and the finely powdered inorganic filler of the component (iv) are first mixed together in a three-roll mill, yielding a mixture. Subsequently, this mixture, the condensation catalyst of the component (ii), and any optional components are placed in a Thinky Conditioning Mixer (manufactured by Thinky Corporation) and mixed together for two minutes, thereby yielding the composition of the present invention.

Furthermore, when curing the composition, a step curing process is preferably conducted across a range from 80 to 200° C. For example, the composition is preferably first subjected to curing at 80° C. for one hour, subsequently heat cured at 150° C. for a further one hour, and then heat cured at 200° C. for 8 hours. By using step curing with these stages, the composition undergoes more satisfactory curing, and the occurrence of foaming within the cured product can be suppressed to a suitable level.

The glass transition point (Tg) of the cured product obtained by curing the above composition is usually too high to enable detection with a commercially available measuring device (for example, a thermomechanical tester manufactured by Ulvac-Riko Inc., (product name: TM-7000, measurement range: 25 to 200° C.)), indicating an extremely superior level of heat resistance for the cured product.

<Applications>

A composition of the present invention is useful for sealing LED elements, and particularly for sealing blue LED and ultraviolet LED elements, but because the composition exhibits excellent levels of heat resistance, ultraviolet light resistance, and transparency, it can also be used in a variety of other applications described below, including display materials, optical recording materials, materials for optical equipment and optical components, fiber optic materials, photoelectronic organic materials, and peripheral materials for semiconductor integrated circuits.

1. Display Materials

Examples of display materials include peripheral materials for liquid crystal display devices, such as substrate materials for liquid crystal displays, optical wave guides, prism sheets, deflection plates, retardation plates, viewing angle correction films, adhesives, and films for use with liquid crystals such as polarizer protection films; sealants, anti-reflective films, optical correction films, housing materials, front glass protective films, substitute materials for the front glass, adhesives, and the like for the new generation, flat panel, color plasma displays (PDP); substrate materials, optical wave guides, prism sheets, deflection plates, retardation plates, viewing angle correction films, adhesives, and polarizer protection films and the like for plasma addressed liquid crystal (PALC) displays; front glass protective films, substitute materials for the front glass, and adhesives and the like for organic EL (electroluminescence) displays; and various film substrates, front glass protective films, substitute materials for the front glass, and adhesives and the like for field emission displays (FED).

2. Optical Recording Materials

Examples of optical recording materials include disk substrate materials, pickup lenses, protective films, sealants, and adhesives and the like for use with VD (video disks), CD, CD-ROM, CD-R/CD-RW, DVD+R/DVD+RW/DVD-RAM, MO, MD, PD (phase change disk), and optical cards.

3. Materials for Optical Equipment

Examples of materials for optical equipment include lens materials, finder prisms, target prisms, finder covers, and light-receiving sensor portions and the like for steel cameras; lenses and finders for video cameras; projection lenses, protective films, sealants, and adhesives and the like for projection televisions; and lens materials, sealants, adhesives, and films and the like for optical sensing equipment.

4. Materials for Optical Components

Examples of materials for optical components include fiber materials, lenses, waveguides, element sealants, and adhesives and the like around optical switches within optical transmission systems; fiber optic materials, ferrules, sealants, and adhesives and the like around optical connectors; sealants and adhesives and the like for passive fiber optic components and optical circuit components such as lenses, waveguides and LED elements; and substrate materials, fiber materials, element sealants, and adhesives and the like for optoelectronic integrated circuits (OEIC).

5. Fiber Optic Materials

Examples of fiber optic materials include illumination light guides for decorative displays; industrial sensors, displays and indicators; and fiber optics for transmission infrastructure or household digital equipment connections.

6. Peripheral Materials for Semiconductor Integrated Circuits

Examples of peripheral materials for semiconductor integrated circuits include resist materials for microlithography for generating LSI and ultra LSI materials.

7. Photoelectronic Organic Materials

Examples of photoelectronic organic materials include peripheral materials for organic EL elements; organic photorefractive elements; optical-optical conversion devices such as optical amplification elements, optical computing elements, and substrate materials around organic solar cells; fiber materials; and sealants and adhesives for the above types of elements.

Next is a description of a method of applying an aforementioned composition to the surface of a LED element using a screen printing method. First, the surface of the LED element is covered with a mask containing a predetermined pattern of openings, and the composition is then soaked into a squeegee. Subsequently, by moving the squeegee across the mask, thereby forcing the composition down and across the mask, the composition can be used to fill the openings within the mask (the filling step). Subsequently, the mask is removed. In this manner, the surface of the LED element is coated with the composition.

Although dependent on the actual conditions employed during screen printing, such as the squeegee speed, the printing pressure, the clearance (the gap between the mask and the surface being printed during the printing process), the squeegee angle, and the degree of squeezing, the viscosity of the composition at 23° C. is preferably within a range from 1×10 Pa·s to 1×10⁵ Pa·s, and even more preferably from 50 Pa·s to 2,000 Pa·s (measured using a DV-II digital viscometer manufactured by Brookfield Engineering Labs, Inc., U.S.A., rotational speed: 0.3 rpm), and the thixotropic index is preferably within a range from 1.0 to 15.0, and even more preferably from 3.0 to 9.0.

The composition layer formed in this manner is then cured in the manner described below. Namely, curing is preferably conducted using a step curing process, in which, for example, the composition layer is cured by heating at 60 to 100° C. (for example, for 1 to 2 hours), followed by heating at 120 to 160° C. (for example, for 1 to 2 hours), and then heating at 180 to 220° C. (for example, for 6 to 12 hours).

### EXAMPLES

As follows is a description of specifics of the present invention using a series of Examples, although the present invention is in no way limited by these Examples.

The methyltrimethoxysilane used in the synthesis examples is KBM13 (a brand name) manufactured by Shin-Etsu Chemical Co., Ltd., and the dimethyldimethoxysilane is KBM22 (a brand name), also manufactured by Shin-Etsu Chemical Co., Ltd.

### Synthesis Example 1

A stirrer and a condenser tube were fitted to a 1 L three-neck flask. This flask was then charged with 109 g (0.8 mols) of methyltrimethoxysilane, 24 g (0.2 mols) of dimethyldimethoxysilane, and 106 g of isobutyl alcohol, and the mixture was cooled in ice with constant stirring. With the temperature inside the reaction system maintained at 0 to 20° C., 60.5 g of a 0.05 N hydrochloric acid solution was added dropwise. Following completion of the dropwise addition, the reaction mixture was stirred for 7 hours under reflux at 80° C. Subsequently, the reaction solution was cooled to room temperature, and 150 g of xylene was added to dilute the reaction solution. The reaction solution was then poured into a separating funnel, and washed repeatedly with 300 g samples of water until the electrical conductivity of the separated wash water fell to no more than 2.0 μS/cm. The water was then removed from the washed reaction solution by azeotropic distillation, and following adjustment of the volatile fraction to 30% by mass, the solution was aged for 12 hours at room temperature, yielding a mixture of an organopolysiloxane 1 (79.1 g) with a weight average molecular weight of 19,000, represented by a formula (4) shown below:
(CH₃)_{1.2}(OX)_{0.25}SiO_{1.28} (4)
(wherein, X represents a combination of hydrogen atoms, methyl groups, and isobutyl groups), and 33.9 g of a mixed alcohol.

### Synthesis Example 2

A stirrer and a condenser tube were fitted to a 1 L three-neck flask. This flask was then charged with 68.1 g (0.5 mols) of methyltrimethoxysilane, 60.1 g (0.5 mols) of dimethyldimethoxysilane, and 118 g of isobutyl alcohol, and the mixture was cooled in ice with constant stirring. With the temperature inside the reaction system maintained at 0 to 20° C., 54 g of a 0.05 N hydrochloric acid solution was added dropwise. Following completion of the dropwise addition, the reaction mixture was stirred for 7 hours under reflux at 80° C. Subsequently, the reaction solution was cooled to room temperature, and 150 g of xylene was added to dilute the reaction solution. The reaction solution was then poured into a separating funnel, and washed repeatedly with 300 g samples of water until the electrical conductivity of the separated wash water fell to no more than 2.0 μS/cm. The water was then removed from the washed reaction solution by azeotropic distillation, and following adjustment of the volatile fraction to 30% by mass, the solution was aged for 12 hours at room temperature, yielding a mixture of an organopolysiloxane 2 (76.3 g) with a weight average molecular weight of 9,000, represented by a formula (5) shown below:
(CH₃)_{1.5}(OX)_{0.22}SiO_{1.14} (5)
(wherein, X represents a combination of hydrogen atoms, methyl groups, and isobutyl groups), and 32.7 g of a mixed alcohol.

### Synthesis Example 3

A stirrer and a condenser tube were fitted to a 1 L three-neck flask. This flask was then charged with 115.8 g (0.85 mols) of methyltrimethoxysilane, 18.0 g (0.15 mols) of dimethyldimethoxysilane, and 102 g of isobutyl alcohol, and the mixture was cooled in ice with constant stirring. With the temperature inside the reaction system maintained at 0 to 20° C., 78.3 g of a 0.05 N hydrochloric acid solution was added dropwise. Following completion of the dropwise addition, the reaction mixture was stirred for 7 hours under reflux at 80° C. Subsequently, the reaction solution was cooled to room temperature, and 150 g of xylene was added to dilute the reaction solution. The reaction solution was then poured into a separating funnel, and washed repeatedly with 300 g samples of water until the electrical conductivity of the separated wash water fell to no more than 2.0 μS/cm. The water was then removed from the washed reaction solution by azeotropic distillation, and following adjustment of the volatile fraction to 30% by mass, the solution was aged for an extended period (72 hours) at room temperature, yielding a mixture of an organopolysiloxane 3 (68.6 g) with a weight average molecular weight of 98,000, represented by a formula (6) shown below:
(CH₃)_{1.15}(OX)_{0.23}SiO_{1.31} (6)
(wherein, X represents a combination of hydrogen atoms, methyl groups, and isobutyl groups), and 29.4 g of a mixed alcohol.

### Synthesis Example 4

A stirrer and a condenser tube were fitted to a 1 L three-neck flask. This flask was then charged with 27.2 g (0.2 mols) of methyltrimethoxysilane, 96.2 g (0.8 mols) of dimethyldimethoxysilane, and 106 g of isobutyl alcohol, and the mixture was cooled in ice with constant stirring. With the temperature inside the reaction system maintained at 0 to 20° C., 57.1 g of a 0.05 N hydrochloric acid solution was added dropwise. Following completion of the dropwise addition, the reaction mixture was stirred for 7 hours under reflux at 80° C. Subsequently, the reaction solution was cooled to room temperature, and 150 g of xylene was added to dilute the reaction solution. The reaction solution was then poured into a separating funnel, and washed repeatedly with 300 g samples of water until the electrical conductivity of the separated wash water fell to no more than 2.0 μS/cm. The water was then removed from the washed reaction solution by azeotropic distillation, and the volatile fraction was adjusted to 30% by mass, yielding a mixture of an organopolysiloxane C1 (69.3 g) with a weight average molecular weight of 16,000, represented by a formula (7) shown below:
(CH₃)_{1.8}(OX)_{0.22}SiO_{0.99} (7)
(wherein, X represents a combination of hydrogen atoms, methyl groups, and isobutyl groups), and 29.7 g of a mixed alcohol.

### Synthesis Example 5

A stirrer and a condenser tube were fitted to a 1 L three-neck flask. This flask was then charged with 136.2 g (1.0 mols) of methyltrimethoxysilane and 106 g of isobutyl alcohol, and the mixture was cooled in ice with constant stirring. With the temperature inside the reaction system maintained at 0 to 20° C., 81 g of a 0.05 N hydrochloric acid solution was added dropwise. Following completion of the dropwise addition, the reaction mixture was stirred for 7 hours under reflux at 80° C. Subsequently, the reaction solution was cooled to room temperature, and 150 g of xylene was added to dilute the reaction solution. The reaction solution was then poured into a separating funnel, and washed repeatedly with 300 g samples of water until the electrical conductivity of the separated wash water fell to no more than 2.0 μS/cm. The water was then removed from the washed reaction solution by azeotropic distillation, and following adjustment of the volatile fraction to 30% by mass, the solution was aged for 12 hours at room temperature, yielding a mixture of an organopolysiloxane C2 (73.5 g) with a weight average molecular weight of 23,000, represented by a formula (8) shown below:
(CH₃)_{1.0}(OX)_{0.24}SiO_{1.38} (8)
(wherein, X represents a combination of hydrogen atoms, methyl groups, and isobutyl groups), and 31.5 g of a mixed alcohol.

### Synthesis Example 6

A stirrer and a condenser tube were fitted to a 1 L three-neck flask. This flask was then charged with 109 g (0.8 mols) of methyltrimethoxysilane, 24 g (0.2 mols) of dimethyldimethoxysilane, and 106 g of isobutyl alcohol, and the mixture was cooled in ice with constant stirring. With the temperature inside the reaction system maintained at 0 to 20° C., 60.5 g of a 0.05 N hydrochloric acid solution was added dropwise. Following completion of the dropwise addition, the reaction mixture was stirred for 24 hours at room temperature. Subsequently, 150 g of xylene was added to dilute the reaction solution. The reaction solution was then poured into a separating funnel, and washed repeatedly with 300 g samples of water until the electrical conductivity of the separated wash water fell to no more than 2.0 μS/cm. The water was then removed from the washed reaction solution by azeotropic distillation, and the volatile fraction was adjusted to 30% by mass, yielding a mixture of an organopolysiloxane C3 (67.2 g) with a weight average molecular weight of 3,100, represented by a formula (9) shown below:
(CH₃)_{1.2}(OX)_{1.21}SiO_{0.79} (9)
(wherein, X represents a combination of hydrogen atoms, methyl groups, and isobutyl groups), and 28.8 g of a mixed alcohol.

### Synthesis Example 7

A stirrer and a condenser tube were fitted to a 1 L three-neck flask. This flask was then charged with 40.9 g (0.3 mols) of methyltrimethoxysilane, 170.8 g (0.7 mols) of diphenyldimethoxysilane, and 106 g of isobutyl alcohol, and the mixture was cooled in ice with constant stirring. With the temperature inside the reaction system maintained at 0 to 20° C., 55.1 g of a 0.05 N hydrochloric acid solution was added dropwise. Following completion of the dropwise addition, the reaction mixture was stirred for 7 hours under reflux at 80° C. Subsequently, the reaction solution was cooled to room temperature, and 150 g of xylene was added to dilute the reaction solution. The reaction solution was then poured into a separating funnel, and washed repeatedly with 300 g samples of water until the electrical conductivity of the separated wash water fell to no more than 2.0 μS/cm. The water was then removed from the washed reaction solution by azeotropic distillation, and the volatile fraction was adjusted to 30% by mass, yielding a mixture of an organopolysiloxane C4 (71.4 g) with a weight average molecular weight of 15,400, represented by a formula (10) shown below:
(CH₃)_{0.3}(C₆H₅)_{1.4}(OX)_{0.16}SiO_{1.07} (10)
(wherein, X represents a combination of hydrogen atoms, methyl groups, and isobutyl groups), and 30.6 g of a mixed alcohol.

### Examples 1 to 11, Comparative Examples 1 to 8

Compositions were prepared by blending the organopolysiloxanes 1 to 3, and C1 to C4 obtained in Synthesis Examples 1 to 7 with condensation catalysts, solvents (including the aforementioned mixed alcohols), and finely powdered inorganic fillers in the proportions shown in Table 1. The screen printing characteristics of these compositions, and the characteristics (crack resistance, adhesion, ultraviolet light resistance, and heat resistance) of the cured products (cured films) obtained by curing the compositions were tested and evaluated in accordance with the methods described below.

<Evaluation Methods>

1. Screen Printing Characteristics

Each of the obtained compositions was applied with a squeegee using stainless steel molding test patterns (10 mm×10 mm×0.2 mm, 5 mm×5 mm×0.2 mm, and 2 mm×2 mm×0.2 mm), and was then subjected to a step curing at 80° C. for one hour, 150° C. for one hour, and then 200° C. for one hour, yielding cured films (of substantially square shape) with a dried film thickness of 0.15 mm. The external appearance of these cured films was evaluated visually. If no abnormalities were observed at the corner portions of the square-shaped cured films (that is, no rounding), then the screen printing characteristics were evaluated as “good”, and were recorded as A, if slight rounding was observed at the corner portions of the square-shaped cured films, the screen printing characteristics were evaluated as “fair”, and were recorded as B, and if the corner portions of the square-shaped cured films were significantly rounded, the screen printing characteristics were evaluated as “poor”, and were recorded as C.

2. Crack Resistance

Each of the obtained compositions was placed in a Teflon (registered trademark) coated mold (50 mm×50 mm×2 mm), subsequently subjected to step curing at 80° C. for one hour, 150° C. for one hour, and 200° C. for one hour, and then post-cured for 8 hours at 200° C., thus yielding a cured film with a dried film thickness of 1 mm. The cured film was inspected visually for the presence of cracks. If no cracks were visible in the cured film, the crack resistance was evaluated as “good”, and was recorded as A, whereas if cracks were detected, the resistance was evaluated as “poor”, and was recorded as B. Furthermore, if a cured film was not able to be prepared, a “measurement impossible” evaluation was recorded as C.

3. Adhesion

Each of the obtained compositions was applied to a glass substrate using an immersion method, subsequently subjected to step curing at 80° C. for one hour, 150° C. for one hour, and 200° C. for one hour, and then post-cured for 8 hours at 200° C., thus forming a cured film with a dried thickness of 2 to 3 μm on top of the glass substrate. Using a cross-cut adhesion test, the adhesion of the cured film to the glass substrate was investigated. In the cross-cut adhesion test, the cured film formed on top of the glass substrate was cut with a sharp blade right through to the substrate so as to form sections of a fixed size (1 mm×1 mm), an adhesive tape was affixed to the surface of the cut sections and pressed down firmly, and a corner of the adhesive tape was then grasped and pulled rapidly away from the substrate in a vertical direction. The number of individual sections amongst the total number of sections (100) that were not peeled off the substrate are shown in the tables. Furthermore, in those cases where cracks had developed in the cured product, making adhesion measurement impossible, the result was recorded in the table as x.

4. Ultraviolet Light Resistance

Each of the obtained compositions was placed in a Teflon (registered trademark) coated mold (40 mm×20 mm×0.4 mm), subsequently subjected to step curing at 80° C. for one hour, 150° C. for one hour, and 200° C. for one hour, and then post-cured for 8 hours at 200° C., thus yielding a cured film with a dried film thickness of 0.2 mm. This cured film was then irradiated with UV radiation (30 mW) for 24 hours using a UV irradiation device (brand name: Eye Ultraviolet Curing Apparatus, manufactured by Eyegraphics Co., Ltd.). The surface of the cured film following UV irradiation was then inspected visually. If absolutely no deterioration of the cured film surface was noticeable, the ultraviolet light resistance was evaluated as “good”, and was recorded as A, if slight deterioration was noticeable, the ultraviolet light resistance was evaluated as “fair”, and was recorded as B, and if significant deterioration was noticeable, the ultraviolet light resistance was evaluated as “poor”, and was recorded as C. Furthermore, if a cured film was not able to be prepared, a “measurement impossible” evaluation was recorded as x.

5. Heat Resistance

Each of the obtained compositions was placed in a Teflon (registered trademark) coated mold (50 mm×50 mm×2 mm), subsequently subjected to step curing at 80° C. for one hour, 150° C. for one hour, and 200° C. for one hour, and then post-cured for 8 hours at 200° C., thus yielding a cured film with a dried film thickness of 1 mm. This cured film was then placed in an oven at 250° C., and the remaining mass was measured after 500 hours in the oven. Using this measured value, the residual mass reduction ratio (%) was determined using the following formula, and this ratio was used as an indicator of the heat resistance.

Residual mass reduction ratio=(mass of cured film following 500 hours in oven)/(mass of cured film immediately following preparation)×100 Furthermore, if a cured film was not able to be prepared, a “measurement impossible” evaluation was recorded as x. In the tables, the heat resistance is shown as a percentage (%).

<Results>

The results obtained for the aforementioned Examples and comparative examples are shown below in Tables 1 to 3.

In the tables, Aerosil 300 used as the component (iv) is a fumed silica with a BET specific surface area of 300 m²/g (manufactured by Nippon Aerosil Co., Ltd.), and Cabosil MS-7 is a fumed silica with a BET specific surface area of 200 m²/g (manufactured by Cabot Corporation, U.S.A.). Furthermore, the organopolysiloxane C5 is a polymer with a nonvolatile fraction of substantially 100% obtained by stripping the mixture of the organopolysiloxane 1 and the mixed alcohol obtained in Synthesis Example 1 to remove the solvents. Furthermore, the methyl group content value represents the theoretical quantity of methyl groups within the organopolysiloxane. The units for the blend quantities of each of the components are parts by mass.

TABLE 1

| | | Example | | | | | |
|---|---|---|---|---|---|---|---|
| | | 1 | 2 | 3 | 4 | 5 | 6 |
| (i) | Organopolysiloxane 1 | 5 | — | — | 5 | 5 | 5 |
| | Organopolysiloxane 2 | — | 5 | — | — | — | — |
| | Organopolysiloxane 3 | — | — | 5 | — | — | — |
| (ii) | Zinc octylate | 0.02 | 0.02 | 0.02 | — | — | 0.02 |
| | Aluminum butoxy- | — | — | — | 0.02 | — | — |
| | bis(ethylacetoacetate) | | | | | | |
| | tetrabutyl titanate | — | — | — | — | 0.02 | — |
| (iii) | Diglyme | 1.0 | 1.0 | 1.0 | 1.0 | 1.0 | 0.7 |
| | Triglyme | — | — | — | — | — | 0.3 |
| | Mixed alcohol | 2.2 | 2.2 | 2.2 | 2.2 | 2.2 | 2.2 |
| (iv) | Aerosil 300 | 1.0 | 1.0 | 1.0 | 1.0 | 1.0 | 1.0 |

| | | | | | | |
|---|---|---|---|---|---|---|
| Methyl group content (% by mass) | 26.0 | 31.5 | 25.1 | 26.0 | 26.0 | 26.0 |
| Weight average molecular weight | 19,000 | 9,000 | 98,000 | 19,000 | 19,000 | 19,000 |
| Screen printing characteristics | A | A | A | A | A | A |
| Crack resistance | A | A | A | A | A | A |
| Adhesion | 100/100 | 100/100 | 100/100 | 100/100 | 100/100 | 100/100 |
| Ultraviolet light resistance | A | A | A | A | A | A |
| Heat resistance (%) | 98 | 95 | 99 | 98 | 97 | 98 |

TABLE 2

| | | Example | | | | |
|---|---|---|---|---|---|---|
| | | 7 | 8 | 9 | 10 | 11 |
| (i) | Organopolysiloxane 1 | 5 | 5 | 5 | 5 | 5 |
| (ii) | Zinc octylate | 0.02 | 0.02 | 0.02 | 0.02 | 0.02 |
| (iii) | Triglyme | 0.3 | — | — | — | — |
| | methylcarbitol | 0.7 | 1.0 | 1.0 | 1.0 | 1.0 |
| | Mixed alcohol | 2.2 | 2.2 | 2.2 | 2.2 | 2.2 |
| (iv) | Aerosil 300 | 1.0 | 1.0 | 0.3 | 2.0 | — |
| | Cabosil MS-7 | — | — | — | — | 1.0 |

| | | | | | |
|---|---|---|---|---|---|
| Methyl group content (% by mass) | 26.0 | 26.0 | 26.0 | 26.0 | 26.0 |
| Weight average molecular weight | 19,000 | 19,000 | 19,000 | 19,000 | 19,000 |
| Screen printing characteristics | A | A | B | A | A |
| Crack resistance | A | A | A | A | A |
| Adhesion | 100/100 | 100/100 | 100/100 | 100/100 | 100/100 |
| Ultraviolet light resistance | A | A | A | A | A |
| Heat resistance (%) | 98 | 98 | 98 | 98 | 98 |

TABLE 3

| | | Comparative Example | | | | | | | |
|---|---|---|---|---|---|---|---|---|---|
| | | 1 | 2 | 3 | 4 | 5 | 6 | 7 | 8 |
| (i) | Organopolysiloxane 1 | — | — | — | — | — | 5 | — | 5 |
| (other) | Organopolysiloxane C1 | 5 | — | — | — | — | — | — | — |
| | Organopolysiloxane C2 | — | 5 | — | — | — | — | — | — |
| | Organopolysiloxane C3 | — | — | 5 | — | — | — | — | — |
| | Organopolysiloxane C4 | — | — | — | 5 | — | — | — | — |
| | Organopolysiloxane C5 | — | — | — | — | 5 | — | 5 | — |
| (ii) | Zinc octylate | 0.02 | 0.02 | 0.02 | 0.02 | 0.02 | — | 0.02 | 0.02 |
| (iii) | Diglyme | 1 | 1 | 1 | 1 | — | — | — | 1 |
| | Mixed alcohol | 2.2 | 2.2 | 2.2 | 2.2 | — | 2.2 | — | 2.2 |
| (iv) | Aerosil 300 | 1 | 1 | 1 | 1 | — | — | 1 | — |

| | | | | | | | | |
|---|---|---|---|---|---|---|---|---|
| Methyl group content (% by mass) | 40.5 | 22.4 | 26.0 | 26.0 | 26 | 26 | 26 | 26 |
| Weight average molecular weight | 16,000 | 23,000 | 3,100 | 15,400 | 19,000 | 19,000 | 19,000 | 19,000 |
| Screen printing characteristics | A | A | A | A | C | C | C | C |
| Crack resistance | A | B | B | A | A | C | A | A |
| Adhesion | 50/100 | x | x | 60/100 | 70/100 | x | 60/100 | 70/100 |
| Ultraviolet light resistance | B | A | A | C | A | x | A | A |
| Heat resistance (%) | 84 | x | x | 91 | 98 | x | 98 | 99 |

1. A curable resin composition for sealing an LED element, comprising:
(i) an organopolysiloxane with a polystyrene equivalent weight average molecular weight of at least 5×10³, represented by an average composition formula (1) shown below:
R¹ₐ(OX)_{b}SiO_{(4-a-b)/2} (1)
(wherein, each R¹ represents, independently, an alkyl group, alkenyl group or aryl group of 1 to 6 carbon atoms, each X represents, independently, a hydrogen atom, or an alkyl group, alkenyl group, alkoxyalkyl group or acyl group of 1 to 6 carbon atoms, a represents a number within a range from 1.05 to 1.5, b represents a number that satisfies 0<b<2, and a+b represents a number that satisfies 1.05<a+b<2),
(ii) a condensation catalyst,
(iii) a solvent, and
(iv) a finely powdered inorganic filler.

2. The composition according to claim 1, wherein said R¹ represents a methyl group.

3. The composition according to claim 1, wherein a proportion of said R¹ groups within said organopolysiloxane (i) is no more than 32% by mass.

4. The composition according to claim 1, wherein said condensation catalyst (ii) is an organometallic catalyst.

5. The composition according to claim 4, wherein said organometallic catalyst contains zinc, aluminum, or titanium atoms.

6. The composition according to claim 5, wherein said organometallic catalyst is zinc octylate.

7. The composition according to claim 1, wherein said solvent (iii) contains at least one organic solvent with a boiling point of 150° C. or higher, and a blend quantity of said solvent is no more than 233 parts by mass per 100 parts by mass of said organopolysiloxane (i).

8. The composition according to claim 1, wherein a BET specific surface area of said finely powdered inorganic filler (iv) is 100 m²/g or greater.

9. A cured product obtained by curing the composition defined in claim 1.

10. A colorless and transparent cured product with a thickness of 10 μm to 3 mm, obtained by curing the composition defined in claim 1 at a temperature of 180° C. or higher.
